(19) United States
(12) Patent Application Publication
(10) Pub. No.: US 2018/0216031 A1
(43) Pub. Date: Aug. 2, 2018

(54) CONCENTRATED SURFACTANT COMPOSITION

(71) Applicant: The Procter & Gamble Company, Cincinnati, OH (US)

(72) Inventors: Scott Leroy CRON, Liberty Township, OH (US); Jeffrey John SCHEIBEL, Glendale, OH (US); Patrick Christopher STENGER, Fairfield, OH (US); Marc Eric GUSTWILLER, Cincinnati, OH (US); Douglas James WILDEMUTH, Cincinnati, OH (US)

(21) Appl. No.: 15/417,251

(22) Filed: Jan. 27, 2017

(51) Int. Cl. C11D 1/22; C11D 1/29; C11D 3/37; C11D 3/43; C11D 3/20; C11D 11/00; C11D 3/04

(52) U.S. Cl. CPC C11D 1/22; C11D 1/29; C11D 3/3723; C11D 3/43; C11D 3/044; C11D 11/0017; C11D 11/0023; C11D 3/2044; C11D 3/2068

(57) ABSTRACT

Concentrated surfactant compositions that include an alkyl alkoxylated sulfate surfactant, and process for making such compositions. Detergent compositions made from such concentrated surfactant compositions, and process for making such detergent compositions.

### FIELD OF THE INVENTION

The present disclosure relates to concentrated surfactant compositions that include an alkyl alkoxylated sulfate surfactant, and process for making such compositions. The present disclosure further relates to detergent compositions made from such concentrated surfactant compositions, and process for making such detergent compositions.

### BACKGROUND OF THE INVENTION

Concentrated surfactant compositions are useful for making detergent compositions, such as laundry or dish detergent compositions. Because they have high activity, they can be transported relatively efficiently. Furthermore, they can be combined and diluted with other detergent ingredients or carriers to arrive at a desired level of activity.

However, concentrated surfactant compositions, particularly those that contain a high proportion of anionic alkyl alkoxylated sulfate surfactant, may also present viscosity and/or stability challenges. The viscosity of such compositions may be relatively high, making the compositions difficult to process or pump, for example out of a rail car or from a storage tank to a manufacturing line. The compositions may also suffer from phase splits, which can lead to inconsistencies in the final product and/or aesthetic problems. Even upon dilution with water, concentrated compositions that include anionic alkyl alkoxylated sulfate surfactant may form a highly viscous hexagonal phase, which can be very challenging to process.

To counteract viscosity and/or stability issues, organic solvents may be added to the concentrated surfactant compositions. However, organic solvents may add cost without providing much performance benefit in the final product.

There is a need for improved concentrated surfactant compositions that have a relatively high level of activity, a relatively low level of organic solvent, and that have desirable viscosity and/or phase stability.

### SUMMARY OF THE INVENTION

The present disclosure relates to concentrated surfactant compositions that include alkyl alkoxylated sulfate surfactant.

The present disclosure further relates to a concentrated surfactant composition consisting essentially of: from about 45% to about 60%, by weight of the composition, of a surfactant system, the surfactant system comprising from about 30% to about 51%, by weight of the composition, of alkyl alkoxylated sulfate surfactant, and from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water.

The present disclosure further relates to a process for manufacturing a concentrated surfactant composition, the process comprising the steps of: providing alkyl alkoxylated sulfate surfactant, linear alkyl benzene sulphonate surfactant, an organic solvent system, an alkalizing agent, and water; and combining the components in the proportions described herein to form the concentrated surfactant composition.

The present disclosure further relates to a detergent composition comprising the concentrated surfactant composition described herein and a detergent adjunct.

The present disclosure further relates to a process for manufacturing a liquid or gel-form detergent composition comprising the steps of: providing a concentrated surfactant composition as described herein and combining the concentrated surfactant composition with at least one adjunct to form a detergent composition.

The present disclosure further relates to the use of linear alkyl benzene sulphonate surfactant to reduce the amount of organic solvent required to form an isotropic concentrated surfactant composition.

### DETAILED DESCRIPTION OF THE INVENTION

The present disclosure relates to concentrated surfactant compositions that contain a relatively high level of alkyl alkoxylated sulfate surfactant, such as alkyl ethoxylated sulfate surfactant (“AES”). While organic solvents can be added to improve the viscosity and/or stability of the concentrated compositions, solvents typically add cost to a composition without adding performance benefits to final compositions.

It has been surprisingly found that another surfactant, linear alkyl benzene sulfonate (“LAS”), can be added to the concentrated composition to provide viscosity and/or stability benefits, thereby enabling the level of organic solvent to be decreased. LAS is commonly used in final products alongside of AES and provides more performance benefits, such as cleaning benefits in final product than organic solvents does. Spiking the concentrated composition with LAS enables the composition's activity level to be remain relatively high without sacrificing formulation space or paying unnecessary cost.

The components and properties of the concentrated surfactant compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein with regard to surfactants that may have an acid form, “neutralized” means that the surfactant is in salt form, such as a sodium salt. As used herein with regard to surfactants that may have an acid form, “preneutralized” means that the surfactant is in salt form prior to being combined with at least one other component of the disclosed compositions. The pH of such (pre)neutralized surfactants in a 10% aqueous solution may be about 7 or above. Typically the alkyl alkoxylated sulfate surfactant is pre-neutralized with an alkalizing agent in order to avoid reversion to the sulfate and alcohol. In contrast, LAS is typically stable at acidic pH and so it can be added to the concentrated surfactant composition as an acid or preneutralized.

As used herein, “isotropic” means a clear mixture (having no visible haziness and/or dispersed particles) and having a uniform transparent appearance. For example, the compositions of the present disclosure may be characterized by a % transmittance of greater than about 80%, or greater than about 90%, at a wavelength of 570 nm measured at room temperature via a standard 10 mm pathlength cuvette with a Beckman DU spectrophotometer using deionized water as blank, in the absence of dyes and/or opacifiers.

As used herein, the term “alkoxy” is intended to include C1-C8 alkoxy and C1-C8 alkoxy derivatives of polyols having repeating units such as butylene oxide, glycidol oxide, ethylene oxide or propylene oxide. The terms “ethylene oxide,” “propylene oxide” and “butylene oxide” may be shown herein by their typical designation of “EO,” “PO” and “BO,” respectively.

As used herein “average molecular weight” is reported as a weight average molecular weight, as determined by its molecular weight distribution; as a consequence of their manufacturing process, polymers disclosed herein may contain a distribution of repeating units in their polymeric moiety.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Concentrated Surfactant Composition

The present disclosure relates to concentrated surfactant compositions. The compositions described herein may be intermediate compositions intended to be combined with other ingredients to form a final product. The concentrated surfactant compositions of the present disclosures are sometimes considered to be surfactant pastes.

The concentrated surfactant compositions may comprise, may consist essentially of, or may consist of the following components: a surfactant system that may include an alkyl alkoxylated sulfate surfactant and a linear alkyl benzene sulfonate surfactant; an organic solvent system; an alkalizing agent; and water. These components are described in more detail below.

The concentrated surfactant composition may consisting essentially of: a surfactant system, the surfactant system comprising from about 30% to about 51%, by weight of the composition, of alkyl alkoxylated sulfate surfactant, and from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water.

The concentrated surfactant compositions may comprise: from about 30% to about 51%, by weight of the composition, of alkyl alkoxylated sulfate surfactant; from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water; where the composition comprises no more than 2, or no more than 1, additional ingredients. The composition may further comprise a polyalkyleneimine (PEI) polymer, preferably an alkoxylated PEI.

The concentrated surfactant composition may consisting essentially of: a surfactant system, the surfactant system comprising from about 30% to about 51%, by weight of the composition, of sodium-neutralized alkyl alkoxylated sulfate surfactant, and from about 2% to about 21%, by weight of the composition, of sodium-neutralized linear alkyl benzene sulphonate surfactant; from about 15% to about 24%, by weight of the composition, of an organic solvent system; optionally, a sodium-containing alkalizing agent, preferably present in an amount of from about 0.1% to about 1% by weight of the composition; and water.

The concentrated surfactant composition may be in the form of a liquid, gel, and/or paste. Typically, the concentrated surfactant composition is not a solid composition, such as a granular or powdered composition. The concentrated surfactant composition may be non-particulate. The concentrated surfactant compositions may have a viscosity of less than about 2000 cps, or less than about 1000 cps, or less than about 500 cps, measured at 10 s⁻¹ at 25° C. The concentrated surfactant compositions may have a viscosity of from about 1 to about 2000 cps, or from about 10 to about 1000 cps, or from about 10 to about 500 cps, measured at 10 s⁻¹ at 25° C. Having a relatively low viscosity may facilitate transporting, pumping, and/or processing the compositions. For example, viscosity of the concentrated composition may influence whether the composition is pumped out of a rail car via the top or bottom of the car.

It may be desirable for the concentrated surfactant composition to be phase stable and/or have a clear appearance, as such compositions may be easier to process and/or incorporate into a final product. The concentrated surfactant composition may be isotropic, which can be indicative of the composition being phase stable. The concentrated surfactant composition may remain as a single phase, isotropic solution after 2 weeks at 20° C., and/or 2 weeks at 40° C. The concentrated surfactant composition may have a percent transmittance (% T) at 570 nm of at least about 80%, or of at least about 85%, or of at least about 90%, or of at least about 95%, or of at least about 98%, or of at least about 99%. Percent transmittance is determined according to the Percent Transmittance method provided in the Test Methods section below.

The concentrated surfactant composition may have an alkaline pH in a 10% (weight/volume) solution of the composition at 20±2° C. The concentrated surfactant composition may have a pH of from about 9 to about 13, or preferably from about 10 to about 13, in a 10% (weight/volume) solution of the composition at 20±2° C.

The concentrated surfactant composition may be characterized by a Reserve Alkalinity (RA) value. RA is a measure of the buffering capacity of the detergent composition (g/NaOH/100 g detergent composition) determined by titrating a 1% (w/v) solution of detergent composition with hydrochloric acid to pH 7.5 and is determined according to the method provided in the Test Methods section below. The concentrated surfactant composition may have a Reserve Alkalinity of from about 0.3 to about 0.9, or from about 0.45 to about 0.75. Such a Reserve Alkalinity can help to maintain the alkaline pH of the compositions described herein. Because alkyl alkoxylated sulfate surfactants can undergo acid-catalyzed hydrolysis reactions in acidic environments, it can be particularly desirable for compositions comprising such surfactants to have a certain Reserve Alkalinity.

### Surfactant System

The concentrated surfactant compositions described herein have a surfactant system. The concentrated surfactant compositions may comprise from about 40%, or from about 45%, or from about 50%, to about 60%, by weight of the composition, of a surfactant system. The concentrated surfactant compositions may comprise from about 40%, or from about 45%, or from about 55%, to about 60%, or to about 56%, or to about 55%, or to about 53%, or to about 50%, by weight of the composition, of a surfactant system. The concentrated surfactant system may comprise from about 45%, or from about 50%, or from about 55%, to about 60%, by weight of the composition, of total surfactant.

The surfactant system may comprise anionic surfactant. The anionic surfactant of the surfactant system may comprise, or consist essentially of, alkyl alkoxylated sulfate surfactant, linear alkyl benzene sulfonate surfactant, or mixtures thereof. The surfactant system may be substantially free of nonionic surfactant, cationic surfactant, amphoteric surfactant, and/or zwitterionic surfactant. The surfactant system may be substantially free of nonionic surfactant.

The surfactant system may consist essentially of no more than two types of surfactants. It is recognized, however, that the surfactant system may include minor portions of, for example, raw material inputs, hydrolyzed reaction products, or other impurities related to the surfactants making up the major portion of the surfactant system, or other impurities.

The surfactants present in the surfactant system may be present either partially or completely in acid form or as a salt, typically a water-soluble salt. Suitable counterions include alkali metal cation, typically sodium, or ammonium or substituted ammonium, typically sodium. The surfactants, either separately or together, may be preneutralized prior to being combined with one or more of the other components of the concentrated surfactant system.

Alkyl Alkoxylated Sulfate

The surfactant system may comprise alkyl alkoxylated sulfate surfactant. The alkyl alkoxylated surfactant may be the major portion of the surfactant system. The alkyl alkoxylated surfactant may be linear, branched, or combinations thereof.

The alkyl alkoxylated sulfate surfactant may present at a level of from about 30% to about 51%, or from about 38% to about 48%, or from about 40% to 46%, by weight of the composition.

The alkyl alkoxylated sulfate surfactant may be an alkyl ethoxylated sulfate surfactant, an alkyl propoxylated surfactant, or mixtures thereof, preferably an alkyl ethoxylated sulfate surfactant. The alkyl alkoxylated sulfate surfactant may have a weight average degree of alkoxylation, preferably ethoxylation of from about 0.8 to about 3.5, more preferably from about 1.5 to about 3, even more preferably from about 1.8 to about 2.5.

When the alkyl alkoxylated sulfate surfactant is a mixture of alkyl alkoxylated sulfate surfactant, the alkoxylation degree is the weight average alkoxylation degree of all the components of the mixture (weight average alkoxylation degree). In the weight average alkoxylation degree calculation the weight of alkyl alkoxylated sulfate surfactant components not having alkoxylated groups should also be included. Weight average alkoxylation degree is calculated in the following manner:

Weight average alkoxylation degree=(x1*alkoxylation degree of surfactant 1+x2*alkoxylation degree of surfactant 2+ . . . )/(x1+x2+ . . . )

wherein x1, x2, . . . are the weights in grams of each sulfated anionic surfactant of the mixture and alkoxylation degree is the number of alkoxy groups in each sulfated anionic surfactant.

The alkyl alkoxylated sulfate surfactant may be alkyl ethoxylated surfactant having a narrow range of ethoxylation. The alkyl ethoxylated surfactant may include a distribution of alkyl ethoxylated surfactants where less than about 7% by weight of the total alkyl ethoxylated surfactant are alkyl ethoxylated surfactant having n≥3 and less than about 35% by weight of the total alkyl ethoxylated surfactant are alkyl ethoxylated surfactants having n=0, where n is the number of ethoxylates (EO) groups in the surfactant (AEₙS).

The alkyl alkoxylated sulfate may have a weight average alkyl chain length of from about 8 to about 18, or from about 10 to about 16 carbon atoms, preferably from about 12 to about 15 carbon atoms, even more preferably from about 13 to about 15 carbon atoms.

The alkyl alkoxylated sulfate may be alkyl ethoxylated surfactant having an average alkyl chain length of from about 14 to about 15 carbon atoms, and an average degree of ethoxylation of from about 1.7 to about 2.7, preferably about 2.5. The alkyl alkoxylated sulfate may be C45 AE_{2.5}S, which has a weight average alkyl chain length of from 14 to 15 carbons and a weight average ethoxylation degree of 2.5.

If the alkyl alkoxyalted sulfate is a branched alkyl alkoxylated sulfate, the branching group may be an alkyl. The alkyl may be selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the invention. The branched alkyl alkoxylated sulfated anionic surfactant may be an alkyl ethoxy sulfates. The level of branching can range from 1% to 96%, preferably 1% to 50%, 5% to 25%, 50% to 70% or15% to 25%. The alkyl alkoxyalted sulfate can be free of branching.

Alkyl alkoxylated sulfate surfactants are commercially available with a variety of chain lengths, ethoxylation and branching degrees. Commercially available sulfates include, those based on Neodol alcohols ex the Shell company, Lial—Isalchem and Safol ex the Sasol company, natural alcohols ex The Procter & Gamble Chemicals company.

Linear Alkyl Benzene Sulfonate

The surfactant system may comprise linear alkyl benzene sulfonate surfactant (LAS). The linear alkyl benzene sulfonate surfactant may present at a level of from about 6% to about 16%, or from about 7% to about 12%, by weight of the composition.

The linear alkyl benzene sulphonate surfactant has a weight average alkyl chain length of from about 10 to about 16, preferably from about 11 to about 13, carbon atoms. The weight average alkyl chain length of the LAS may be about 11.8 carbons. The LAS may be present in acid form or as a salt, preferably as a sodium salt.

Suitable alkyl benzene sulphonate (LAS) is obtainable, and is preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as those catalyzed by hydrofluoric acid (HF), may also be suitable.

The weight ratio of AES to LAS in the surfactant system may be in the range of from about 25:1 to about 1:1, or from about 20:1 to about 1.5:1, or from about 15:1 to about 3:1, or from about 10:1 to about 5:1, or from about 7:1 to about 6:1.

### Organic Solvent System

The concentrated surfactant systems of the present disclosure may comprise an organic solvent system. The organic solvent system may contribute to desirable viscosity and stability profiles in the compositions of the present disclosure. However, it may be desirable to keep the amount of solvent system as low as possible while still maintaining the desired viscosity and/or stability as the solvents add little to the performance benefits of the end product.

The organic solvent system may be present at a level of from about 15% to about 24%, or from about 16% to about 22%, preferably 17% to about 20%, by weight of the composition. The weight ratio of surfactant system to organic solvent system may be from about 3:1 to about 5:1, or from about 3.25:1 to about 4:1, or about 3.5:1. The weight ratio of alkyl alkoxylated sulfate surfactant to organic solvent system may be from about 2.75:1 to about 4:1, or from about 2.9:1 to about 3.5:1, or about 3:1. The weight ratio of LAS to organic solvent system may be from about 0.1:1 to about 2:1.

The organic solvent may comprise at least one, or at least two, or at least three organic solvents. The organic solvents system may comprise no more than four, or no more than three, or no more than two, or no more than one organic solvent.

The organic solvent system may comprise a solvent selected from the group consisting of monohydric alcohols such as ethanol, propanol, butanol, isopropanol; dihydric alcohols such as diethylene glycol, propanediol, butanediol and diols wherein the hydroxyl groups present in said diol are attached to adjacent atoms; polyalkylene glycols such as polyethylene glycol; polyhydric alcohols such as glycerine; alkoxylated glycerine, alkoxylated diols, and combinations thereof. The organic solvent system may comprise a solvent selected from the group consisting of: glycerine, ethanol, propanediol, diethylene glycol, dipropylene glycol, butanediol and combinations thereof.

The organic solvent system may comprise propanediol. The weight ratio of linear alkyl benezene sulphonate surfactant to propanediol is from about 2:1 to about 0.4:1.

The organic solvent system may comprise propanediol and diethylene glycol. The weight ratio of propanediol to diethylene glycol may be from about 1:2 to about 4:1. Alternatively, the organic solvent system may be substantially free of diethylene glycol.

The organic solvent system may comprise propanediol and ethanol. The weight ratio of propanediol to ethanol may be from about 1:1 to about 2.5:1, or from about 1.05:1 to about 2.11:1, or from about 1.5:1 to about 2.1:1.

The organic solvent system may be substantially free of amino-functional organic solvents.

### Alkalizing Agent

The concentrated surfactant compositions of the present disclosure may comprise an alkalizing agent. The concentrated surfactant compositions may comprise from about 0.5% to about 5.5% of the alkalizing agent. The alkalizing agent may be present in the concentrated surfactant composition at a level sufficient to neutralize the surfactants. When the surfactants are neutralized, whether they enter the composition preneutralized or are neutralized by the addition of the alkalizing agent, a small amount of excess alkalizing agent may be present in the composition, for example, from about 0.1% to about 1% by weight of the concentrated surfactant composition.

The alkalizing agent may be a caustic agent. Suitable caustic agents include alkali metal hydroxides, alkali earth metal hydroxides, ammonium (substituted or unsubstituted) hydroxides, or mixtures thereof. The alkalizing agent may be an alkali metal hydroxide, preferably sodium hydroxide.

The alkalizing agent may be an alkanolamine, such as monoethanolamine (MEA) or triethanolamine (TEA).

### Water

The concentrated surfactant compositions of the present disclosure may contain water. The water can act as a solvent for the surfactant system in addition to the organic solvent system. When formulating the present concentrated compositions, some of the organic solvent system that might otherwise be necessary may be replaced by water. Water is typically present in at least some end detergent products, such as a heavy duty liquid detergent composition, and typically costs less than organic solvent.

The concentrated surfactant compositions of the present disclosure may contain the components described herein (including surfactant system, organic solvent system, and alkalizing agent), with water to balance. The concentrated surfactant compositions of the present disclosure may comprise from about 20% to about 37%, or from about 21% to about 35%, or from about 23% to about 32%, by weight of the composition, of water.

Water may be added as free or neat water. In some aspects, water enters the composition as a component of other ingredients, for example, as a carrier of sodium hydroxide or organic acid. It is understood that water may also be formed from the neutralization of acids in the composition, for example, from acid-form alkyl ethoxylated sulfate (HAES) or acid-form LAS (HLAS).

### Other Components

The concentrated surfactant compositions described herein, while typically being limited in the number of ingredients, may include other components as suitable. Suitable components may include a polymer, an antimicrobial agent, other surfactants (including branched anionic surfactants and/or amine oxide), hydrotropes (such as sodium cumene sulfate), fatty acid and/or salts thereof, or mixtures of any of the foregoing.

The concentrated surfactant composition may include a polymer. The polymer may provide a performance benefit in the final end-use detergent composition. The polymer may be a polyalkyleneimine polymer, preferably a polyethyleneimine (PEI) polymer. The PEI polymer may be an alkoxylated PEI polymer. The alkoxylated PEI polymer may be an ethoxylated PEI polymer, which may be free of propoxy groups. The PEI may be linear or branched, preferably branched. The PEIs used in preparing some suitable compounds can have a weight average molecular weight prior to ethoxylation of from about 400 to about 1500, or from about 500 to about 1000, or about 600, which represents at least about 14 ethyleneimine units. The polymer may be an ethoxylated polyethyleneimine, typically having an average ethoxylation degree per ethoxylation chain of from about 15 to about 25, or about 18 to about 22, or about 20. A suitable example includes PEI 600 E20, available from BASF. The polymer may be present in the concentrated surfactant composition at a level of from about 1% to about 5%, or from about 2% to about 4.1%, by weight of the concentrated surfactant composition.

Other suitable alkoxylated polyalkylenimine polymers may include propoxylated polyalkylenimine (e.g., PEI) polymers. The propoxylated polyalkylenimine (e.g., PEI) polymers may also be ethoxylated. The propoxylated polyalkylenimine (e.g., PEI) polymers may have inner polyethylene oxide blocks and outer polypropylene oxide blocks, the degree of ethoxylation and the degree of propoxylation not going above or below specific limiting values. The ratio of polyethylene blocks to polypropylene blocks (n/p) may be from about 0.6, or from about 0.8, or from about 1, to a maximum of about 10, or a maximum of about 5, or a maximum of about 3. The n/p ratio may be about 2. The propoxylated polyalkylenimines may have PEI backbones having molecular weights (prior to alkoxylation) of from about 200 g/mol to about 1200 g/mol, or from about 400 g/mol to about 800 g/mol, or about 600 g/mol. The molecular weight of the propoxylated polyalkylenimines may be from about 8,000 to about 20,000 g/mol, or from about 10,000 to about 15,000 g/mol, or about 12,000 g/mol.

Suitable propoxylated polyalkylenimine polymers may include compounds of the following structure:

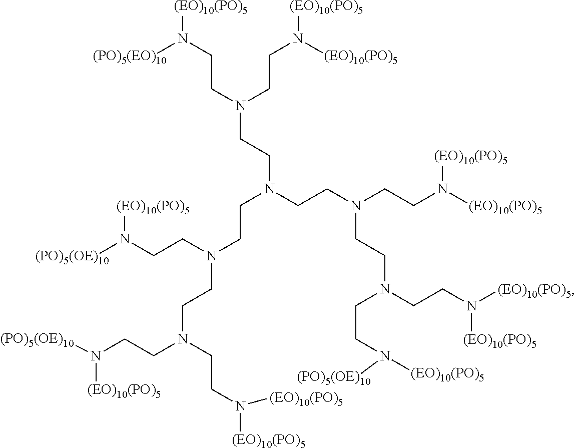

where EOs are ethoxylate groups and POs are propoxylate groups. The compound shown above is a PEI where the molar ratio of EO:PO is 10:5 (e.g., 2:1). Other similar, suitable compounds may include EO and PO groups present in a molar ratio of about 10:5 or about 24:16.

### Detergent Compositions

The concentrated surfactant compositions of the present disclosure are useful for making end-product detergent compositions intended to be sold to and used by consumers or institutions. Thus, the present disclosure also relates to detergent compositions. The detergent compositions of the present disclosure may comprise a concentrated surfactant composition, as described herein, and a detergent adjunct.

The detergent composition may have a form selected from the group consisting of a liquid, a gel, or a paste. The detergent composition may be a fabric care composition. The detergent composition may be a liquid laundry detergent, a gel detergent, a liquid hand dishwashing composition, a laundry pretreat product, or mixtures thereof.

The detergent composition may comprise from about 18 to about 76%, by weight of the detergent composition, of the concentrated surfactant composition. The detergent composition may comprise a sufficient amount of the concentrated surfactant composition to provide about 5% to about 40%, by weight of the detergent composition, of surfactant to the detergent composition.

The detergent composition may comprise a detergent adjunct. Any suitable detergent adjunct may be added. The detergent adjunct may be selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

The detergent adjunct may comprise additional surfactant. Additional surfactants may be selected from anionic surfactants, nonionic surfactants, amphoteric surfactants, cationic surfactants, amphoteric surfactants, and combinations thereof. Suitable anionic surfactants may include additional LAS or branched anionic surfactants. Suitable nonionic surfactants may include ethoxylated alcohol surfactants. Suitable zwitterionic surfactants may include amine oxide.

### Process for Manufacturing a Concentrated Surfactant Composition

The present disclosure relates to a process for manufacturing the concentrated surfactant composition disclosed herein. The process may comprise the steps of: providing alkyl alkoxylated sulfate surfactant, linear alklyl benzene sulphonate surfactant, an organic solvent system, an alkalizing agent, and water; and combining the components in the following proportions to form the concentrated surfactant composition: from about 30% to about 51%, by weight of the composition, of the alkyl alkoxylated sulfate surfactant, from about 2% to about 21%, by weight of the composition, of the linear alkyl benzene sulphonate surfactant; from about 15% to about 24%, by weight of the composition, of the organic solvent system; from about 0.5% to about 5.5%, by weight of the composition, of the alkalizing agent; and water to balance.

The process may include providing the alkyl alkoxylated sulfate surfactant and/or the linear alklyl benzene sulphonate surfactant in preneutralized form, preferably preneutralized with sodium. The process may include the step of combining the alkyl alkoxylated sulfate surfactant and/or the linear alklyl benzene sulphonate surfactant with the alkalizing agent to preneutralize the surfactant(s) prior to combining with the organic solvent system. The composition may include a small excess of the alkalizing agent, preferably a caustic alkalizing agent such as sodium hydroxide, beyond what is required to neutralize the surfactants, whether or not they are provided as being preneutralized. Therefore, the concentrated surfactant composition may comprise from about 0.1% to about 1%, by weight of the concentrated surfactant composition, of an alkalizing agent, preferably a caustic alkalizing agent such as sodium hydroxide. It may be desirable to preneutralize the surfactants so that the pH can be more tightly controlled.

The process for manufacturing the concentrated surfactant composition may comprise the steps of: providing preneutralized alkyl alkoxylated sulfate surfactant, preneutralized linear alklyl benzene sulphonate surfactant, an organic solvent system, an alkalizing agent, and water; and combining the components in the following proportions to form the concentrated surfactant composition: from about 30% to about 51%, by weight of the composition, of the preneutralized alkyl alkoxylated sulfate surfactant, from about 2% to about 21%, by weight of the composition, of the preneutralized linear alkyl benzene sulphonate surfactant; from about 15% to about 24%, by weight of the composition, of the organic solvent system; from about 0.1% to about 1%, by weight of the composition, of the alkalizing agent; and water to balance.

### Process for Manufacturing a Detergent Composition

The present disclosure relates to a process for manufacturing the detergent compositions, such as liquid or gel-form detergent compositions, disclosed herein. The process may comprise the steps of: providing a concentrated surfactant composition as described herein and combining the concentrated surfactant composition with at least one adjunct to form a detergent composition.

The step of providing the concentrated surfactant composition may include the steps of preparing the concentrated surfactant composition at a first location and transporting the concentrated surfactant composition to a second location, and where the combining step occurs at the second location. The transporting may occur by rail car.

The concentrated surfactant composition of the present process may consist essentially of: from about 30% to about 51%, by weight of the composition, of alkyl alkoxylated sulfate surfactant; from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water. The surfactants may be preneutralized, in which case the alkalizing agent may be present at a level of from about 0.1% to about 1%, by weight of the concentrated surfactant composition.

The concentrated surfactant compositions of the present disclosure are useful as surfactant intermediates that may be incorporated into different end-use detergent compositions. Therefore, the present disclosure relates to a process for manufacturing a plurality of detergent compositions, the process comprising the steps of: providing a first portion of the concentrated surfactant composition as described herein; combining the first portion with first detergent adjuncts to form a first detergent composition; providing a second portion of the concentrated surfactant composition as described herein; combining the second portion with second detergent adjuncts to form a second detergent composition that is compositionally different from the first detergent composition. For the processes described herein, the concentrated surfactant composition may be provided at a single batch and then divided in to first and second portions, but does not need to be. The first and second portions could be provided as separate batches, manufactured as separate places or separate times.

The second detergent composition may be different from the first detergent compositions in terms of the adjuncts added, the relative proportions in which the adjuncts and/or concentrated surfactant composition were added, pH, aesthetics (including color and/or perfume), or any other suitable compositional difference.

### Use of Linear Alkyl Benzene Sulfonate

The present disclosure relates to a use of linear alkyl benzene sulfonate surfactant to reduce the amount of organic solvent required to form an isotropic concentrated surfactant composition, where the composition includes from about 30% to about 51%, by weight of the composition, of sodium-neutralized alkyl alkoxylated sulfate surfactant.

### Combinations

Specifically contemplated combinations of the disclosure are herein described in the following lettered paragraphs. These combinations are intended to be illustrative in nature and are not intended to be limiting.

A. A concentrated surfactant composition consisting essentially of: from about 45% to about 60%, by weight of the composition, of a surfactant system, the surfactant system comprising from about 30% to about 51%, by weight of the composition, of alkyl alkoxylated sulfate surfactant, and from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water.

B. A concentrated surfactant composition according to paragraph A, wherein the alkyl alkoxylated sulfate surfactant is alkyl ethoxylated surfactant, preferably having a weight average degree of ethoxylation of from about 0.8 to about 3.5, more preferably from about 1.5 to about 3, even more preferably from about 1.8 to about 2.5.

C. A concentrated surfactant composition according to any of paragraphs A-B, wherein the alkyl alkoxylated sulfate has an average alkyl chain length of from about 10 to about 16 carbon atoms, preferably from about 12 to about 15 carbon atoms, even more preferably from about 13 to about 15 carbon atoms.

D. A concentrated surfactant composition according to any of paragraphs A-C, wherein the alkyl alkoxylated sulfate surfactant is alkyl ethoxylated surfactant having an average alkyl chain length of from about 13 to about 15 carbon atoms, and an average degree of ethoxylation of from about 1.7 to about 2.7, preferably about 2.5.

E. A concentrated surfactant composition according to any of paragraphs A-D, wherein the alkyl alkoxylated sulfate surfactant is present at a level of from about 38% to about 48%, or from about 40% to 46%, by weight of the composition.

F. A concentrated surfactant composition according to any of paragraphs A-E, wherein the linear alkyl benzene sulphonate surfactant is present at a level of from about 6% to about 16%, or from about 7% to about 12%, by weight of the composition.

G. A concentrated surfactant composition according to any of paragraphs A-F, wherein the linear alkyl benzene sulphonate surfactant has an average alkyl chain length of from about 10 to about 16, preferably from about 11 to about 13, carbon atoms.

H. A concentrated surfactant composition according to any of paragraphs A-G, wherein the composition comprises from about 40% to about 60%, preferably 50 to about 56% of total surfactant.

I. A concentrated surfactant composition according to any of paragraphs A-H, wherein the composition is substantially free of nonionic surfactant.

J. A concentrated surfactant composition according to any of paragraphs A-I, wherein the organic solvent is present at a level of from about 16% to about 22%, preferably 17% to about 20%, by weight of the composition.

K. A concentrated surfactant composition according to any of paragraphs A-J, wherein the organic solvent system comprises at least two, or at least three, organic solvents.

L. A concentrated surfactant composition according to any of paragraphs A-K, wherein the organic solvent system comprises a solvent selected from the group consisting of: monohydric alcohols; dihydric alcohol; polyalkylene glycols; polyhydric alcohols; alkoxylated glycerine; alkoxylated diols; and combinations thereof.

M. A concentrated surfactant composition according to any of paragraphs A-L, wherein the organic solvent system comprises a solvent selected from the group consisting of: glycerine, ethanol, propanediol, diethylene glycol, dipropylene glycol, butanediol and combinations thereof.

N. A concentrated surfactant composition according to any of paragraphs A-M, wherein the organic solvent system comprises propanediol, and wherein the weight ratio of linear alkyl benezene sulphonate surfactant to propanediol is from about 2:1 to about 0.4:1.

O. A concentrated surfactant composition according to any of paragraphs A-N, wherein the organic solvent system is substantially free of amino-functional organic solvents.

P. A concentrated surfactant composition according to any of paragraphs A-O, wherein the alkalizing agent is an alkali metal hydroxide, preferably sodium hydroxide.

Q. A concentrated surfactant composition according to any of paragraphs A-P, wherein the composition has a Reserve Alkalinity from 0.3 to 0.9.

R. A concentrated surfactant composition according to any of paragraphs A-Q, wherein the composition has a % T at 540 nm of at least 80%.

S. A concentrated surfactant composition according to any of paragraphs A-R, wherein the composition has a viscosity of less than about 2000 cps, or less than about 1000 cps, or less than about 500 cps, measured at 10 s⁻¹ at 25° C.

T. A concentrated surfactant composition according to any of paragraphs A-S, wherein the composition remains as a single-phase, isotropic solution after 2 weeks at 20° C., and/or 2 weeks at 40° C.

U. A detergent composition comprising the concentrated surfactant composition according to any of paragraphs A-T, and a detergent adjunct.

V. A detergent composition according to paragraph U, wherein the adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

W. The detergent composition according to any of paragraphs U-V, wherein said detergent composition has a form selected from the group consisting of a liquid laundry detergent, a gel detergent, a liquid hand dishwashing composition, a laundry pretreat product, and mixtures thereof.

X. A process for manufacturing a concentrated surfactant composition, the process comprising the steps of: providing alkyl alkoxylated sulfate surfactant, linear alkyl benzene sulphonate surfactant, an organic solvent system, an alkalizing agent, and water; and combining the following components in the following proportions to form the concentrated surfactant composition: from about 30% to about 51%, by weight of the composition, of the alkyl alkoxylated sulfate surfactant, from about 2% to about 21%, by weight of the composition, of the linear alkyl benzene sulphonate surfactant; from about 15% to about 24%, by weight of the composition, of the organic solvent system; from about 0.5% to about 5.5%, by weight of the composition, of the alkalizing agent; and water to balance.

Y. A process for manufacturing a liquid or gel-form detergent composition comprising the steps of: providing a concentrated surfactant composition consisting essentially of: from about 30% to about 51%, by weight of the composition, of alkyl alkoxylated sulfate surfactant; from about 2% to about 21%, by weight of the composition, of linear alkyl benzene sulphonate surfactant; from about 15% to about 24%, by weight of the composition, of an organic solvent system; (optionally, where the composition comprises from about 45% to about 60% of total surfactant;) from about 0.5% to about 5.5%, by weight of the composition, of an alkalizing agent; and water; and combining the concentrated surfactant composition with at least one adjunct to form a detergent composition.

Z. A process according to paragraph Y, wherein the step of providing the concentrated surfactant composition includes the steps of preparing the concentrated surfactant composition at a first location and transporting the concentrated surfactant composition to a second location, and wherein the combining step occurs at the second location.

AA. A concentrated surfactant composition comprising: from about 30% to about 51%, by weight of the composition, of alkyl alkoxylated sulfate surfactant; from about 2% to about 21%, by weight of the composition, of linear alkyl benzene sulphonate surfactant; from about 15% to about 24%, by weight of the composition, of an organic solvent system; from about 0.5% to about 5.5%, by weight of the composition, of an alkalizing agent; and water; wherein the composition comprises no more than 2, or no more than 1, additional ingredients.

AB. A concentrated surfactant composition according to paragraph AA, wherein the composition further comprises a polyalkyleneimine (PEI) polymer, preferably an alkoxylated PEI.

AC. A concentrated surfactant composition according to any of paragraphs AA-AB, wherein the composition has a Reserve Alkalinity from 0.3 to 0.9.

AD. A concentrated surfactant composition according to any of paragraphs AA-AD, wherein the composition has a viscosity of less than about 2000 cps, or less than about 1000 cps, or less than about 500 cps, measured at 10 s⁻¹ at 25° C.

AE. A concentrated surfactant composition consisting essentially of: from about 45% to about 60%, by weight of the composition, of a surfactant system, the surfactant system comprising from about 30% to about 51%, by weight of the composition, of sodium-neutralized alkyl alkoxylated sulfate surfactant, and from about 2% to about 21%, by weight of the composition, of sodium-neutralized linear alkyl benzene sulphonate surfactant; from about 15% to about 24%, by weight of the composition, of an organic solvent system; optionally, a sodium-containing alkalizing agent, preferably present in an amount of from about 0.1% to about 1% by weight of the composition; and water.

AF. A use of linear alkyl benzene sulfonate surfactant for reducing the amount of organic solvent required to form an isotropic concentrated surfactant composition, where the composition includes from about 32% to about 51%, by weight of the composition, of sodium-neutralized alkyl alkoxylated sulfate surfactant, and optionally, wherein the composition comprises from about 45% to about 60%, by weight of the composition, of total surfactant.

### Test Methods

### Viscosity

The viscosity is measured with a Rheometer, such as the AR G2 Rheometer from TA Instruments, according to the manufacturer's instructions. Viscosity is measured using 40 mm parallel plates at a constant temperature of 25° C. Shear rates of 1 to 100 s⁻¹ are measured on a logarithmic scale with five points per decade.

### Percent Transmittance

The Percent Transmittance is measured with a UV-Visible spectrometer such as a Beckman Coulter DU® 800. A standard 10 mm pathlength cuvette is used for the sample measurement and compared to a deionized water blank. Samples are measured in the in the absence of dyes and/or opacifiers, and at room temperature (20±2° C.).

pH

Unless otherwise stated herein, the pH of the composition is defined as the pH of an aqueous 10% (weight/volume) solution of the composition at 20±2° C. Any meter capable of measuring pH to ±0.01 pH units is suitable. Orion meters (Thermo Scientific, Clintinpark—Keppekouter, Ninovesteenweg 198, 9320 Erembodegem—Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution.

The 10% aqueous solution of the detergent is prepared according to the following procedure. A sample of 10±0.05 grams is weighted with a balance capable of accurately measuring to ±0.02 grams. The sample is transferred to a 100 mL volumetric flask, diluted to volume with purified water (deionized and/or distilled water are suitable as long as the conductivity of the water is <5 μS/cm), and thoroughly mixed. About 50 mL of the resulting solution is poured into a beaker, the temperature is adjusted to 20±2° C. and the pH is measured according to the standard procedure of the pH meter manufacturer. The manufacturer's instructions should be followed to set up and calibrate the pH assembly.

### Reserve Alkalinity

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.5 i.e in order to calculate Reserve Alkalinity as defined herein:

Reserve Alkalinity (to pH 7.5) as % alkali in g NaOH/100 g product=

$$\frac{T \times M \times 40 \times Vol}{10 \times Wt \times Aliquot}$$

T=titre (ml) to pH 7.5

M=Molarity of HCl=0.2

40=Molecular weight of NaOH

Vol=Total volume (ie. 1000 ml)

Wt=Weight of product (10 g)

Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free deionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate RA to pH 7.5.

### EXAMPLES

The examples provided below are intended to be illustrative in nature and are not intended to be limiting.

### Example 1. Process of Making a Concentrated Surfactant Composition

60 g batches of a concentrated alkyl ethoxylated sulfate (AES) compositions AES paste are prepared according the following order of addition according to desired concentrations (see, e.g., Table B below): acid-form linear alkyl benzene sulfonate (HLAS) (97% active); propanediol (100% active); water; ethanol (92.4% active); NaOH (50% active); AES (70% active); and then diethylene glycol (DEG) (100% active). After the NaOH addition, the resultant is stirred at 300 RPM for about one minute; the AES and DEG are then added, and the resultant is stirred at 300-500 RPM for ˜3 min.

### Example 2. Process of Making a Concentrated Surfactant Composition

An ethoxylated alcohol is provided. The ethoxylated alcohol is sulfated by known processes to form alkyl ethoxylated sulfate surfactant. To this surfactant, the following are added in a neutralization loop: organic solvent, LAS, water, and a neutralizing agent.

### Example 3

The compositions used in Trials A and B were prepared in the following manner.

60 g batches of NaC45E2.5S AES paste were prepared according the following order of addition: HLAS (97% active, C11.8, Stepan, Northfield, Ill.), 1,2-Propanediol (100% active), Water, Ethanol (92.4% Active), NaOH (50% Active), NaC45E2.5S AES (70% Active, Neodol 45E2.5 from Shell Chemicals, Houston, Tex.) and then Diethylene Glycol (100% Active) according to the concentrations in the table. All components are denoted as 100% active and accounting for the NaOH neutralization of the HLAS in the table. After the NaOH addition the resultant was stirred at 300 RPM for ˜1 min before the AES and Diethylene Glycol were added after which the resultant was stirred at 300-500 RPM for ˜3 min Samples were placed in a 60 C oven for two hours and then split into two 30 gram portions and placed in 20 C and 40 C controlled temperature rooms. Samples were assessed visually and via cross polarized microscopy for physical stability to determine the number of phase and identity of the phases. Typically, a clear, flowable composition is preferred.

Trial A: Comparative Compositions with Organic Solvents

As shown in Table A, results show in the absence of HLAS in the NaC45E2.5S AES Paste, at least 21.1% total organic solvent comprised of 1,2-Propanediol, Diethylene Glycol and Ethanol is required to achieve a clear, isotropic, flowable paste after two weeks storage at 20 C. For clarity, only the compositions at the edge of the phase boundary are shown.

TABLE A

| | Paste Composition (% Active) | | | | | | | | |
|---|---|---|---|---|---|---|---|---|---|
| | | 1,2- | | | Total | | | | Two Week |
| | | Propane- | Diethylene | | Organic | NaC45 | | | Stability |
| No. | Water | diol | Glycol | Ethanol | Solvent | E2.5S | NaLAS | NaOH | Result, 20 C. |
| A1 | 25.91 | 14.00 | 0.00 | 7.09 | 21.09 | 53.00 | 0.00 | 0.45 | Clear, Flows |
| A2 | 26.91 | 13.00 | 0.00 | 7.09 | 20.09 | 53.00 | 0.00 | 0.45 | Opaque |
| A3 | 27.91 | 12.00 | 0.00 | 7.09 | 19.09 | 53.00 | 0.00 | 0.45 | Gel |
| A4 | 25.90 | 11.00 | 3.01 | 7.09 | 21.10 | 53.00 | 0.00 | 0.45 | Clear, Flows |
| A5 | 26.90 | 10.00 | 3.01 | 7.09 | 20.10 | 53.00 | 0.00 | 0.45 | Opaque |
| A6 | 27.90 | 9.00 | 3.01 | 7.09 | 19.10 | 53.00 | 0.00 | 0.45 | Gel |

Trial B: Compositions According to the Present Disclosure with LAS

As shown in Trial B, results show in the presence LAS in the NaC45E2.5S AES Paste, the level of organic solvent required to achieve a clear, isotropic, flowable paste after two weeks storage at 20 C can be reduced to 15.0% in the case of 5.1 or 7.7% LAS, a significant reduction in the level of organic solvent. The organic solvent is comprised of 1,2-Propanediol and Ethanol. For clarity, only the compositions at the edge of the phase boundary are shown.

TABLE B

| | Paste Composition (% Active) | | | | | | | | |
|---|---|---|---|---|---|---|---|---|---|
| | | 1,2- | | | Total | | | | Two Week |
| | | Propane- | Diethylene | | Organic | NaC45 | | | Stability |
| No. | Water | diol | Glycol | Ethanol | Solvent | E2.5S | NaLAS | NaOH | Result, 20 C. |
| B1 | 28.06 | 12.00 | 0.00 | 7.02 | 19.02 | 50.35 | 2.57 | 0.48 | Clear, Flows |
| B2 | 30.06 | 10.00 | 0.00 | 7.02 | 17.02 | 50.35 | 2.57 | 0.48 | Hazy, Flows |
| B3 | 30.14 | 10.00 | 0.00 | 7.02 | 17.02 | 47.70 | 5.14 | 0.51 | Clear, Flows |
| B4 | 32.14 | 8.00 | 0.00 | 7.02 | 15.02 | 47.70 | 5.14 | 0.51 | Gel |
| B5 | 32.22 | 8.00 | 0.00 | 7.02 | 15.02 | 45.05 | 7.71 | 0.53 | Clear, Flows |
| B6 | 34.29 | 6.00 | 0.00 | 7.02 | 13.02 | 42.40 | 10.29 | 0.56 | Split Phase |
| B7 | 36.29 | 4.00 | 0.00 | 7.02 | 11.02 | 42.40 | 10.29 | 0.56 | Gel |
| B8 | 27.71 | 12.00 | 0.00 | 7.02 | 19.02 | 42.40 | 10.87 | 0.57 | Clear, Flows |
| B9 | 29.71 | 10.00 | 0.00 | 7.02 | 17.02 | 42.40 | 10.87 | 0.57 | Hazy, Flows |
| B10 | 31.71 | 8.00 | 0.00 | 7.02 | 15.02 | 42.40 | 10.87 | 0.57 | Split Phase |
| B11 | 28.45 | 12.00 | 0.00 | 7.02 | 19.02 | 37.10 | 15.42 | 0.61 | Clear, Flows |
| B12 | 30.45 | 10.00 | 0.00 | 7.02 | 17.02 | 37.10 | 15.42 | 0.61 | Hazy, Flows |
| B13 | 32.45 | 8.00 | 0.00 | 7.02 | 15.02 | 37.10 | 15.42 | 0.61 | Split Phase |
| B14 | 28.61 | 12.00 | 0.00 | 7.02 | 19.02 | 31.80 | 20.56 | 0.66 | Clear, Flows |
| B15 | 30.61 | 10.00 | 0.00 | 7.02 | 17.02 | 31.80 | 20.56 | 0.66 | Split Phase |

### Example 4

The compositions used in Trials C and D were prepared in the following manner.

60 g batches of C25E1.8S AES paste were prepared according the following order of addition: HLAS (97% active), 1,2-Propanediol (100% active), Water, Ethanol (92.4% Active), NaOH (50% Active) and then C25E1.8S AES (79% Active) resulting in the concentrations in the table. All components are denoted as 100% active and accounting for the NaOH neutralization of the HLAS in the table. After the NaOH addition the resultant was stirred at 300 RPM for ˜1 min before the AES was added after which the resultant was stirred at 300-500 RPM for ˜3 min. Samples were placed in a 60 C oven for two hours and then transferred to a 40 C controlled temperature room for 15 days. Samples were assessed visually and via cross polarized microscopy to determine the number and identity of phases. Samples were then placed into a 20 C controlled temperature room for an additional 15 days and then assessed for stability in the same manner.

Trial C: Comparative Compositions with Organic Solvents

As shown in Table C, results show in the absence of HLAS in the NaC25E1.8S AES Paste, at least 19.0% total organic solvent comprised of 1,2-Propanediol and Ethanol is required to achieve a clear, isotropic, flowable paste after two weeks storage at 20 C. For clarity, only the compositions at the edge of the phase boundary are shown.

TABLE C

| | Paste Composition (% Active) | | | | | | | |
|---|---|---|---|---|---|---|---|---|
| | | 1,2- | | Total | | | | Two Week |
| | | Propane- | | Organic | NaC25 | | | Stability |
| No. | Water | diol | Ethanol | Solvent | E1.8S | NaLAS | NaOH | Result, 20 C. |
| C1 | 27.98 | 12.00 | 7.02 | 19.02 | 53.00 | 0.00 | 0.40 | Clear, Flows |
| C2 | 29.98 | 10.00 | 7.02 | 17.02 | 53.00 | 0.00 | 0.40 | Gel |

Trial D: Compositions According to the Present Disclosure with HLAS

As shown in Table D, results show in the presence of LAS in the NaC25E1.8S AES Paste, the level of organic solvent required to achieve a clear, isotropic, flowable paste after two weeks storage at 20 C can be reduced to 13.0% in the case of 10.3 or 15.4% HLAS, a significant reduction in the level of organic solvent. The organic solvent is comprised of 1,2-Propanediol and Ethanol. For clarity, only the compositions at the edge of the phase boundary are shown.

TABLE D

| | Paste Composition (% Active) | | | | | | | |
|---|---|---|---|---|---|---|---|---|
| | | 1,2- | | | | | | Two Week |
| | | Propane- | | Total Organic | NaC25 | | | Stability |
| No. | Water | diol | Ethanol | Solvent | E1.8S | NaLAS | NaOH | Result, 20 C. |
| D1 | 28.13 | 12.00 | 7.02 | 19.02 | 47.70 | 5.15 | 0.45 | Clear, Flows |
| D2 | 30.13 | 10.00 | 7.02 | 17.02 | 47.70 | 5.15 | 0.45 | Split Phase |
| D3 | 32.13 | 8.00 | 7.02 | 15.02 | 47.70 | 5.15 | 0.45 | Gel |
| D4 | 34.29 | 6.00 | 7.02 | 13.02 | 42.40 | 10.29 | 0.52 | Clear, Flows |
| D5 | 36.29 | 4.00 | 7.02 | 11.02 | 42.40 | 10.29 | 0.52 | Split Phase |
| D6 | 34.46 | 6.00 | 7.02 | 13.02 | 37.10 | 15.42 | 0.58 | Clear, Flows |
| D7 | 36.46 | 4.00 | 7.02 | 11.02 | 37.10 | 15.42 | 0.58 | Split Phase |
| D8 | 28.62 | 12.00 | 7.02 | 19.02 | 31.80 | 20.56 | 0.63 | Clear, Flows |
| D9 | 30.62 | 10.00 | 7.02 | 17.02 | 31.80 | 20.56 | 0.63 | Split Phase |

### Example 5. Heavy Duty Liquid Laundry Detergent Compositions

Concentrated surfactant compositions according to the present disclosure are used to make heavy duty liquid laundry detergent compositions according to the following formulas, as shown in Table E.

TABLE E

| | A | B | C | D | E | F | G |
|---|---|---|---|---|---|---|---|
| | (wt %) | (wt %) | (wt %) | (wt %) | (wt %) | (wt %) | (wt %) |
| AES | 15 | 11 | 11 | 7 | 22 | 11 | 30 |
| LAS | 9 | 4 | 2 | 2 | 10 | 11 | 6 |
| HSAS | 0 | 3 | 0 | 0 | 0 | 0 | 0 |
| AE | 4 | 0 | 3 | 0 | 5 | 2 | 4 |
| Lauryl Trimethyl Ammonium | 0 | 0 | 0 | 0 | 0.3 | 0 | 0 |
| Chloride | | | | | | | |
| C₁₂₋₁₄ dimethyl Amine Oxide | 0.8 | 0.7 | 0.3 | 0.5 | 0 | 0 | 0 |
| Citric Acid | 2.5 | 4.0 | 1.9 | 2.0 | 0.9 | 2.5 | 0.6 |
| C₁₂₋₁₈ Fatty Acid | 0.8 | 3.5 | 0.6 | 0.99 | 1.2 | 0 | 15.0 |
| Chelant | 0.3 | 0.15 | 0.11 | 0.07 | 0.5 | 0.11 | 0.8 |
| Sodium Formate | 1.6 | 0.1 | 1.2 | 0 | 1.6 | 0 | 0.2 |
| Calcium Formate | 0.1 | 0 | 0 | 0.04 | 0 | 0.13 | 0 |
| Calcium Chloride | 0.01 | 0.08 | 0 | 0 | 0 | 0 | 0 |
| Magnesium Chloride | 0 | 0 | 0 | 0 | 0.02 | 0.04 | 0 |
| Mannanase: Mannaway ® (25 mg | 0.002 | 0.05 | 0 | 0.06 | 0.04 | 0.045 | 0.1 |
| active/g) | | | | | | | |
| Protease (40.6 mg active/g) | 0.8 | 0.6 | 0.07 | 0 | 0.7 | 0.2 | 1.5 |
| Amylase: Stainzyme ® (15 mg | 0.3 | 0 | 0.3 | 0.02 | 0 | 0.6 | 0.1 |
| active/g) | | | | | | | |
| Amylase: Natalase ® (29 mg | 0 | 0.6 | 0.1 | 0.15 | 0.07 | 0 | 0.1 |
| active/g) | | | | | | | |
| Xyloglucanase (Whitezyme ®, | 0.2 | 0.1 | 0 | 0 | 0.01 | 0.05 | 0.2 |
| 20 mg active/g) | | | | | | | |
| Lipex ® (18 mg active/g) | 0.4 | 0.2 | 0.3 | 0.1 | 0.2 | 0 | 0 |
| 4-formyl-phenylboronic acid | 0 | 0 | 0 | 0 | 0.1 | 0.02 | 0.01 |
| Borax | 1.5 | 2.1 | 1.1 | 0.8 | 0 | 1.0 | 0 |
| Ethoxylated Polyethylenimine | 0 | 1.4 | 0 | 4 | 0 | 0 | 0.8 |
| Grease Cleaning Alkoxylated | 1 | 2 | 0 | 0 | 1.5 | 0 | 0 |
| Polyalkylenimine Polymer | | | | | | | |
| PEG-PVAc Polymer | 0.1 | 0.2 | 0.0 | 4 | 0.05 | 0.0 | 1 |
| Zwitterionic ethoxylated | 2.1 | 0 | 0.7 | 1.6 | 0.3 | 1.6 | 0 |
| quaternized sulfated | | | | | | | |
| hexamethylene diamine | | | | | | | |
| Fluorescent Brightener | 0.2 | 0.1 | 0.05 | 0.3 | 0 | 0.3 | 0.2 |
| Diethylene glycol | 4.5 | 0 | 3.6 | 0 | 3.0 | 0 | 0 |
| Ethanol | 2.5 | 2.0 | 1.7 | 1.1 | 3.5 | 3.0 | 7.0 |
| 1,2-Propanediol | 0 | 6.6 | 0 | 1.2 | 3.0 | 2.0 | 8.0 |
| Monoethanolamine | 1.4 | 1.0 | 4.0 | 0.5 | 0 | 0 | To pH 8.2 |
| Cumene sulfonate | 0.0 | 0.2 | 0.5 | 1 | 2 | 0 | 0 |
| Sodium Hydroxide | 0.8 | 0.4 | 0.5 | 0.4 | 0.3 | 0.1 | 0.1 |
| Hydrogenated castor oil | 0.1 | 0 | 0.4 | 0 | 0 | 0 | 0.1 |
| derivative structurant | | | | | | | |
| Suds Suppressor | 0.2 | 0 | 0.1 | 0.4 | 0 | 0 | 0 |
| Perfume | 1.6 | 1.1 | 1.0 | 0.1 | 0.9 | 1.5 | 1.6 |
| Core Shell Melamine- | 0.5 | 0.05 | 0.00 | 0.02 | 0.1 | 0.05 | 0.1 |
| formaldehyde encapsulate | | | | | | | |
| of perfume | | | | | | | |
| Hueing Agent | 0.05 | 0.00 | 0.00 | 0.00 | 0.0 | 0.025 | 0 |

| | |
|---|---|
| *Water, dyes & minors | Balance |

*Based on total cleaning and/or treatment composition weight
All enzyme levels are expressed as % enzyme raw material.

### Example 6. Unit Dose Compositions

Concentrated surfactant compositions according to the present disclosure are used to make unit dose laundry detergent formulations of the present invention are provided below. Such unit dose formulations can comprise one or multiple compartments, formed from water-soluble polyvinyl alcohol film (ex MonoSol LLC, Indiana, USA).

TABLE F

| | H | I | J | K | L |
|---|---|---|---|---|---|
| Ingredient | (wt %) | (wt %) | (wt %) | (wt %) | (wt %) |
| AES | 8 | 14 | 20 | 25 | 4 |
| LAS | 24 | 14 | 10 | 5 | 8 |
| AE | 8 | 13 | 10 | 4 | 20 |
| Citric Acid | 1 | 0.6 | 0.6 | 1.56 | 0.6 |
| C₁₂₋₁₈ Fatty Acid | 4.5 | 9 | 2 | 4 | 14.8 |
| Enzymes | 1 | 1.7 | 1.7 | 2 | 1.7 |
| Ethoxylated | 1.4 | 0 | 4 | 6 | 4 |
| Polyethylenimine | | | | | |
| Chelant | 0.6 | 0.6 | 1.2 | 1.2 | 3 |
| PEG-PVAc Polymer | 4 | 2.5 | 4 | 2.5 | 0 |
| Fluorescent | 0.15 | 0.4 | 0.3 | 0.3 | 0.3 |
| Brightener | | | | | |
| 1,2 propanediol | 6.3 | 13.8 | 13.8 | 6 | 13.8 |
| Glycerol | 12 | 5 | 6.1 | 6.1 | 6.1 |
| Monoethanolamine | 9.8 | 8 | 8 | 8 | 9.8 |
| TIPA | 0 | 0 | 2 | 0 | 0 |
| Triethanolamine | 0 | 2 | 0 | 0 | 0 |
| Sodium Cumene | 0 | 0 | 0 | 0 | 2 |
| sulphonate | | | | | |
| Cyclohexyl | 0 | 0 | 0 | 2 | 0 |
| dimethanol | | | | | |
| Water | 10 | 12 | 15 | 20 | 10 |
| Structurant | 0.1 | 0.14 | 0.14 | 0.1 | 0.14 |
| Perfume | 0.2 | 1.9 | 1 | 1.9 | 1.9 |
| Hueing Agent | 0 | 0.1 | 0.001 | 0.0001 | 0 |

| | |
|---|---|
| Buffers | To pH 8.0 |
| (monoethanolamine) | |
| Solvents (e.g., 1,2 | To 100% |
| propanediol, ethanol) | |

### Example 7. Liquid Laundry Additive Detergent Formulations

Concentrated surfactant compositions according to the present disclosure are used to make bleach and additive detergent formulations, as shown in Table G.

TABLE G

| | M | N | O | P | Q | R |
|---|---|---|---|---|---|---|
| Ingredient | (wt %) | (wt %) | (wt %) | (wt %) | (wt %) | (wt %) |
| AES | 26.3 | 11.5 | 17.4 | 14 | 10 | 20 |
| LAS | 10.6 | 6 | 4 | 5 | 26 | 16 |
| HSAS | 0 | 0 | 0 | 3.5 | 0 | 0 |
| Chelant | 2.5 | 0 | 1.5 | 0 | 0 | 4 |
| 1,2-propandiol | 10.0 | 2.0 | 3.5 | 2.5 | 15.0 | 3.1 |
| Ethanol | 5.0 | 2.5 | 3.5 | 2.5 | 2.0 | 3.6 |
| Soil release agent | 2 | 0 | 0 | 0 | 0 | 0 |
| Ethoxylated Polyethylenimine | 0 | 1.8 | 0 | 0 | 0 | 0 |
| Acrylate Polymer | 0 | 0 | 2.9 | 0 | 0 | 0 |
| Acusol 880 (Hydrophobically | 0 | 0 | 0 | 2 | 1.8 | 2.9 |
| Modified Non-Ionic Polyol) | | | | | | |
| Protease (55 mg/g active) | 0 | 0 | 0 | 0 | 0.1 | 0.1 |
| Amylase (30 mg/g active) | 0 | 0 | 0 | 0 | 0 | 0.02 |
| Perfume | 0 | 0.2 | 0.03 | 0.17 | 0 | 0.15 |
| Fluorescent Brightener | 0.21 | 0 | 0 | 0.15 | 0 | 0.18 |
| Water, other optional | to 100% | to 100% | to 100% | to 100% | to 100% | to 100% |
| agents/components* | balance | balance | balance | balance | balance | balance |

*Other optional agents/components include suds suppressors, structuring agents such as those based on Hydrogenated Castor Oil (preferably Hydrogenated Castor Oil, Anionic Premix), solvents and/or Mica pearlescent aesthetic enhancer. All enzyme levels are expressed as % enzyme raw material.

### Raw Materials for Examples.

LAS is linear alkylbenzenesulfonate having an average aliphatic carbon chain length C₁₁-C₁₂ supplied by Stepan, Northfield, Ill., USA or Huntsman Corp. HLAS is acid form.
AES is C₁₂₋₁₄ alkyl ethoxy (3) sulfate, C₁₂₋₁₅ alkyl ethoxy (1.8) sulfate, C₁₄₋₁₅ alkyl ethoxy (2.5) sulfate supplied by Stepan, Northfield, Ill., USA or Shell Chemicals, Houston, Tex., USA.
AE is selected from C₁₂₋₁₃ with an average degree of ethoxylation of 6.5, C₁₁₋₁₆ with an average degree of ethoxylation of 7, C₁₂₋₁₄ with an average degree of ethoxylation of 7, C₁₄₋₁₅ with an average degree of ethoxylation of 7, or C₁₂₋₁₄ with an average degree of ethoxylation of 9, all supplied by Huntsman, Salt Lake City, Utah, USA.
AS is a C₁₂₋₁₄ sulfate, supplied by Stepan, Northfield, Ill., USA.
HSAS is mid-branched alkyl sulfate as disclosed in U.S. Pat. No. 6,020,303 and U.S. Pat. No. 6,060,443.
C₁₂₋₁₄ Dimethylhydroxyethyl ammonium chloride, supplied by Clariant GmbH, Germany.
C₁₂₋₁₄ dimethyl Amine Oxide is supplied by Procter & Gamble Chemicals, Cincinnati, USA.
Acrylic Acid/Maleic Acid Copolymer is molecular weight 70,000 and acrylate:maleate ratio 70:30, supplied by BASF, Ludwigshafen, Germany.
PEG-PVAc polymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units. Available from BASF (Ludwigshafen, Germany).
Ethoxylated Polyethylenimine is a 600 g/mol molecular weight polyethylenimine core with 20 ethoxylate groups per —NH. Available from BASF (Ludwigshafen, Germany).
Zwitterionic ethoxylated quaternized sulfated hexamethylene diamine is described in WO 01/05874 and available from BASF (Ludwigshafen, Germany).
Grease Cleaning Alkoxylated Polyalkylenimine Polymer is a 600 g/mol molecular weight polyethylenimine core with 24 ethoxylate groups per —NH and 16 propoxylate groups per —NH. Available from BASF (Ludwigshafen, Germany).
Carboxymethyl cellulose is Finnfix® V supplied by CP Kelco, Arnhem, Netherlands.
Amylases (Natalase®, Stainzyme®, Stainzyme Plus®) may be supplied by Novozymes, Bagsvaerd, Denmark.
Savinase®, Lipex®, Celluclean™, Mannaway®, Pectawash®, and Whitezyme® are all products of Novozymes, Bagsvaerd, Denmark.
Proteases may be supplied by Genencor International, Palo Alto, Calif., USA (e.g. Purafect Prime®) or by Novozymes, Bagsvaerd, Denmark (e.g. Liquanase®, Coronase®).
Suitable Fluorescent Whitening Agents are for example, Tinopal® TAS, Tinopal® AMS, Tinopal® CBS-X, Sulphonated zinc phthalocyanine, available from BASF, Ludwigshafen, Germany.
Chelant is selected from, diethylenetetraamine pentaacetic acid (DTPA) supplied by Dow Chemical, Midland, Mich., USA, hydroxyethane di phosphonate (HEDP) supplied by Solutia, St Louis, Mo., USA; Ethylenediamine-N,N′-disuccinic acid, (S,S) isomer (EDDS) supplied by Octel, Ellesmere Port, UK, Diethylenetriamine penta methylene phosphonic acid (DTPMP) supplied by Thermphos, or1,2-dihydroxybenzene-3,5-disulfonic acid supplied by Future Fuels Batesville, Ark., USA
Hueing agent is Direct Violet 9 or Direct Violet 99, supplied by BASF, Ludwigshafen, Germany.
Soil release agent is Repel-o-Tex® PF, supplied by Rhodia, Paris, France or SRN240, available from Clamant.
Suds suppressor agglomerate is supplied by Dow Corning, Midland, Mich., USA
Acusol 880 is supplied by Dow Chemical, Midland, Mich., USA

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A concentrated surfactant composition consisting essentially of:
from about 45% to about 60%, by weight of the composition, of a surfactant system, the surfactant system comprising
from about 30% to about 51%, by weight of the composition, of alkyl alkoxylated sulfate surfactant, and
from about 2% to about 21%, by weight of the composition, of linear alkyl benzene sulphonate surfactant;
from about 15% to about 24%, by weight of the composition, of an organic solvent system;
from about 0.5% to about 5.5%, by weight of the composition, of an alkalizing agent; and
water.

2. A concentrated surfactant composition according to claim 1, wherein the alkyl alkoxylated sulfate surfactant is alkyl ethoxylated surfactant, preferably having a weight average degree of ethoxylation of from about 0.8 to about 3.5, more preferably from about 1.5 to about 3, even more preferably from about 1.8 to about 2.5.

3. A concentrated surfactant composition according to claim 1, wherein the alkyl alkoxylated sulfate has an average alkyl chain length of from about 10 to about 16 carbon atoms, preferably from about 12 to about 15 carbon atoms, even more preferably from about 13 to about 15 carbon atoms.

4. A concentrated surfactant composition according to claim 1, wherein the alkyl alkoxylated sulfate surfactant is alkyl ethoxylated surfactant having an average alkyl chain length of from about 13 to about 15 carbon atoms, and an average degree of ethoxylation of from about 1.7 to about 2.7, preferably about 2.5.

5. A concentrated surfactant composition according to claim 1, wherein the alkyl alkoxylated sulfate surfactant is present at a level of from about 38% to about 48%, or from about 40% to 46%, by weight of the composition.

6. A concentrated surfactant composition according to claim 1, wherein the linear alkyl benzene sulphonate surfactant is present at a level of from about 6% to about 16%, or from about 7% to about 12%, by weight of the composition.

7. A concentrated surfactant composition according to claim 1, wherein the linear alkyl benzene sulphonate surfactant has an average alkyl chain length of from about 10 to about 16, preferably from about 11 to about 13, carbon atoms.

8. A concentrated surfactant composition according to claim 1, wherein the composition comprises from about 40% to about 60%, preferably 50 to about 56% of total surfactant.

9. A concentrated surfactant composition according to claim 1, wherein the composition is substantially free of nonionic surfactant.

10. A concentrated surfactant composition according to claim 1, wherein the organic solvent is present at a level of from about 16% to about 22%, preferably 17% to about 20%, by weight of the composition.

11. A concentrated surfactant composition according to claim 1, wherein the organic solvent system comprises at least two, or at least three, organic solvents.

12. A concentrated surfactant composition according to claim 1, wherein the organic solvent system comprises a solvent selected from the group consisting of: monohydric alcohols; dihydric alcohol; polyalkylene glycols; polyhydric alcohols; alkoxylated glycerine; alkoxylated diols; and combinations thereof.

13. A concentrated surfactant composition according to claim 1, wherein the organic solvent system comprises a solvent selected from the group consisting of: glycerine, ethanol, propanediol, diethylene glycol, dipropylene glycol, butanediol and combinations thereof.

14. A concentrated surfactant composition according to claim 13, wherein the organic solvent system comprises propanediol, and wherein the weight ratio of linear alkyl benezene sulphonate surfactant to propanediol is from about 1:1 to about 0.4:1.

15. A concentrated surfactant composition according to claim 1, wherein the organic solvent system is substantially free of amino-functional organic solvents.

16. A concentrated surfactant composition according to claim 1, wherein the alkalizing agent is an alkali metal hydroxide, preferably sodium hydroxide.

17. A concentrated surfactant composition according to claim 1, wherein the composition has a Reserve Alkalinity from 0.3 to 0.9.

18. A concentrated surfactant composition according to claim 1, wherein the composition has a % T at 540 nm of at least 80%.

19. A concentrated surfactant composition according to claim 1, wherein the composition has a viscosity of less than about 2000 cps, or less than about 1000 cps, or less than about 500 cps, measured at 10 s⁻¹ at 25° C.

20. A concentrated surfactant composition according to claim 1, wherein the composition remains as a single-phase, isotropic solution after 2 weeks at 20° C., and/or 2 weeks at 40° C.

21. A detergent composition comprising the concentrated surfactant composition according to claim 1, and a detergent adjunct.

22. A detergent composition according to claim 21, wherein the adjunct is selected from the group consisting of additional surfactant, a structurant, a builder, a fabric softening agent, a polymer or an oligomer, an enzyme, an enzyme stabilizer, a bleach system, a brightener, a hueing agent, a chelating agent, a suds suppressor, a conditioning agent, a humectant, a perfume, a perfume microcapsule, a filler or carrier, an alkalinity system, a pH control system, a buffer, an alkanolamine, and mixtures thereof.

23. The detergent composition according to claim 21, wherein said detergent composition has a form selected from the group consisting of a liquid laundry detergent, a gel detergent, a liquid hand dishwashing composition, a laundry pretreat product, and mixtures thereof.

24. A process for manufacturing a concentrated surfactant composition, the process comprising the steps of:
providing alkyl alkoxylated sulfate surfactant, linear alklyl benzene sulphonate surfactant, an organic solvent system, an alkalizing agent, and water; and
combining the components in the following proportions to form the concentrated surfactant composition:
from about 30% to about 51%, by weight of the composition, of the alkyl alkoxylated sulfate surfactant,
from about 2% to about 21%, by weight of the composition, of the linear alkyl benzene sulphonate surfactant;
from about 15% to about 24%, by weight of the composition, of the organic solvent system;
from about 0.5% to about 5.5%, by weight of the composition, of the alkalizing agent; and
water to balance.

25. A process for manufacturing a liquid or gel-form detergent composition comprising the steps of:
providing a concentrated surfactant composition consisting essentially of:
from about 30% to about 51%, by weight of the composition, of alkyl alkoxylated sulfate surfactant;
from about 2% to about 21%, by weight of the composition, of linear alkyl benzene sulphonate surfactant;
from about 15% to about 24%, by weight of the composition, of an organic solvent system;
from about 0.5% to about 5.5%, by weight of the composition, of an alkalizing agent; and
water; and
combining the concentrated surfactant composition with at least one adjunct to form a detergent composition.

26. A process according to claim 25,
wherein the step of providing the concentrated surfactant composition includes the steps of preparing the concentrated surfactant composition at a first location and transporting the concentrated surfactant composition to a second location, and
wherein the combining step occurs at the second location.

27. A concentrated surfactant composition comprising:
from about 30% to about 51%, by weight of the composition, of alkyl alkoxylated sulfate surfactant;
from about 2% to about 21%, by weight of the composition, of linear alkyl benzene sulphonate surfactant;
from about 15% to about 24%, by weight of the composition, of an organic solvent system;
from about 0.5% to about 5.5%, by weight of the composition, of an alkalizing agent; and
water;
wherein the composition comprises no more than 2, or no more than 1, additional ingredients.

28. A concentrated surfactant composition according to claim 27, wherein the composition further comprises a polyalkyleneimine (PEI) polymer, preferably an alkoxylated PEI.

29. A concentrated surfactant composition according to claim 27, wherein the composition has a Reserve Alkalinity from 0.3 to 0.9.

30. A concentrated surfactant composition according to claim 27, wherein the composition has a viscosity of less than about 2000 cps, or less than about 1000 cps, or less than about 500 cps, measured at 10 s⁻¹ at 25° C.

31. A concentrated surfactant composition consisting essentially of:
from about 45% to about 60%, by weight of the composition, of a surfactant system, the surfactant system comprising
from about 30% to about 51%, by weight of the composition, of sodium-neutralized alkyl alkoxylated sulfate surfactant, and
from about 2% to about 21%, by weight of the composition, of sodium-neutralized linear alkyl benzene sulphonate surfactant;
from about 15% to about 24%, by weight of the composition, of an organic solvent system;
optionally, a sodium-containing alkalizing agent, preferably present in an amount of from about 0.1% to about 1% by weight of the composition; and
water.

32. A use of linear alkyl benzene sulfonate surfactant for reducing the amount of organic solvent required to form an isotropic concentrated surfactant composition, where the composition includes from about 30% to about 51%, by weight of the composition, of sodium-neutralized alkyl alkoxylated sulfate surfactant.
